(19) United States
(12) Patent Application Publication
(10) Pub. No.: US 2025/0199939 A1
(43) Pub. Date: Jun. 19, 2025

(54) MULTI-PLATFORM TEST FRAMEWORK

(71) Applicant: MICROSOFT TECHNOLOGY LICENSING, LLC, Redmond, WA (US)

(72) Inventors: Steven Rhejohn Barlin SO, Burlington, MA (US); Philip TO, Lexington, MA (US); Andrew BROOKS, Northborough, MA (US); Pawel Zbigniew NOWAKOWSKI, Belmont, MA (US); Umadevi PATIL, Bangalore (IN); Kavita Swapnil KULKARNI, Old Bridge, NJ (US); Manu SHIVALINGAIAH, Bangalore (IN)

(21) Appl. No.: 18/540,787

(22) Filed: Dec. 14, 2023

(51) Int. Cl. G06F 11/36

(52) U.S. Cl. CPC G06F 11/3608; G06F 11/3688

(57) ABSTRACT

Techniques are described for a multi-platform test framework that is configured to generate a target test script indicative of commands and responses for verifying virtual functions implemented in a virtualized computing environment executing a plurality of virtual machines or containers. A translation layer is used to translate the commands and responses of the source test script to equivalent commands and responses usable to verify the virtual function in a second node configured to operate on a second platform of the virtualized computing environment.

### BACKGROUND

There are a variety of 3GPP/5G compliant and EPC/Any-G products and services that comprise a collection of Network Functions (NF's) in the market. However, testing such products and services typically requires different test frameworks. These test frameworks are often adapted to the specific solution and configurations for that solution, which requires a significant of resources and often times those resources are not reusable for other solutions.

Additionally, when MCC or other mobile cloud products are deployed using Kubemetes, they are hosted on a single platform (i.e., Azure, AWS, KVM, Nexus, Hybrid cloud, etc.). Comparing and contrasting how different platforms perform requires completely different configurations of the test environment. This can be extremely costly both in computing resources required and engineering labor. The interfacing between platforms requires working with different platform API's and there is no commonality between APIs that can enable interfacing with all platforms. More generally, there is no universal test framework that can support different public, private, and hybrid cloud platforms.

It is with respect to these considerations and others that the disclosure made herein is presented.

### SUMMARY

The present disclosure provides a universal multi-platform test framework that enables support of various 3GPP/5G compliant EPC/Any-G solutions and mobile networks with the capability to interface with different cloud platforms. The universal multi-platform test framework enables resources such as computing resource allocations and engineering tasks to be more efficiently allocated. The universal multi-platform test framework also centralizes many issues associated with tests or configurations that often have to be propagated to other product test frameworks. For example, when a bug is identified in a test case or configuration, the bug would only need to be fixed in one centralized location. The universal multi-platform test framework further enables modularity that enables efficient functional and performance testing of the product or device under test.

The described techniques can allow for a service provider or customer to more efficiently update and deploy computing resources while maintaining efficient use of computing capacity such as processor cycles, memory, network bandwidth, and power.

This Summary is provided to introduce a selection of concepts in a simplified form that are further described below in the Detailed Description. This Summary is not intended to limit the scope of the claimed subject matter.

### DRAWINGS

The Detailed Description is described with reference to the accompanying figures. In the description detailed herein, references are made to the accompanying drawings that form a part hereof, and that show, by way of illustration, specific embodiments or examples. The drawings herein are not drawn to scale. Like numerals represent like elements throughout the several figures.

FIG. 1 is a diagram illustrating an example architecture in accordance with the present disclosure;

FIG. 2A is a diagram illustrating an example architecture in accordance with the present disclosure;

FIG. 2B is a diagram illustrating an example architecture in accordance with the present disclosure;

FIG. 2C is a diagram illustrating an example architecture in accordance with the present disclosure;

FIG. 3 is a diagram illustrating an example architecture in accordance with the present disclosure;

FIG. 4 is a flowchart depicting an example procedure for managing computing resources in accordance with the present disclosure;

FIG. 5 is an example computing system in accordance with the present disclosure.

### DETAILED DESCRIPTION

Verifying a stable deployment which is robust, efficient and secure is often challenging. Deploying or updating an application in the cloud as a cloud service is not straightforward because of the many factors that need to be taken into account. For example, test frameworks are often adapted to a specific solution and configurations for that solution, which requires a significant of resources. Additionally, when various cloud products are deployed, they are hosted on a single. Comparing and contrasting how different platforms perform requires completely different configurations of the test environment. This can be extremely costly both in computing resources required and engineering labor.

The disclosed embodiments describe a universal multi-platform test framework that enables support of various 3GPP/5G compliant and EPC/Any-G solutions and mobile networks with the capability to interface with different cloud platforms. The universal multi-platform test framework enables resources such as computing resource allocations and engineering tasks to be more efficiently allocated. The universal multi-platform test framework also centralizes many issues associated with tests or configurations that often have to be propagated to other product test frameworks. For example, when a bug is identified in a test case or configuration, the bug would only need to be fixed in one centralized location. The universal multi-platform test framework further enables modularity that enables efficient functional and performance testing of the product or device under test. The universal multi-platform test framework enables encapsulation of NF test configuration and set up. For example, a test can be defined with only required procedures and parameter (e.g., interface and address) and the universal multi-platform test framework will automatically retrieve the associated parameters and network updates for each applicable platform.

The described techniques can allow a user to access results for multiple products at a centralized location or the same product on different platforms and compare performance side by side. This also enables more consistency with the tests. By leveraging standardization of product and service specifications, the universal multi-platform test framework can interface with different products and with different cloud platforms. Furthermore, allowing the platform to be modular enables easy functional and performance testing of the product or device under test. The universal multi-platform test framework enables users to test products without having to expend resources individually creating interfaces for each platform.

In an embodiment, a translation layer is implemented that identifies the type of a remote node and its version, where a remote node can be a test tool, device under test or platform. The type and version information is stored in a translation layer database that includes definitions of commands/command response translations. These translations include rules for converting input strings into output strings.

In an embodiment, strings are command patterns (e.g., regular expression match commands), and translations include string manipulation rules (e.g., regular expression substitution commands). The translation layer includes a translation graph where edges can be:
string substitution regular expressions
other string manipulation rules, like such as reordering, key-word injection
expressions (e.g., code that is executed, for example on the remote node to collect additional information)
In an example, a keyword has been changed first from ‘crash’ to ‘fault’ and later to ‘memimage’
   The purpose of transitions is to define rules/actions for converting an input string into an output string.

The translation layer further includes a detailed workflow that includes command normalization and command lookup in the translation database.

In some embodiments, the present disclosure may be implemented in a mobile edge computing (MEC) environment implemented in conjunction with a 4G, 5G, or other cellular network. MEC is a type of edge computing that uses cellular networks and 5G and enables a data center to extend cloud services to local deployments using a distributed architecture that provide federated options for local and remote data and control management. MEC architectures may be implemented at cellular base stations or other edge nodes and enable operators to host content closer to the edge of the network, delivering high-bandwidth, low-latency applications to end users. For example, the cloud provider's footprint may be co-located at a carrier site (e.g., carrier data center), allowing for the edge infrastructure and applications to run closer to the end user via the 5G network.

Referring to the appended drawings, in which like numerals represent like elements throughout the several FIGURES, aspects of various technologies for remote management of computing resources will be described. In the following detailed description, references are made to the accompanying drawings that form a part hereof, and which are shown by way of illustration specific configurations or examples. While many examples are described using servers and disks, it should be understood that other types of compute nodes and storage devices may be used in other embodiments.

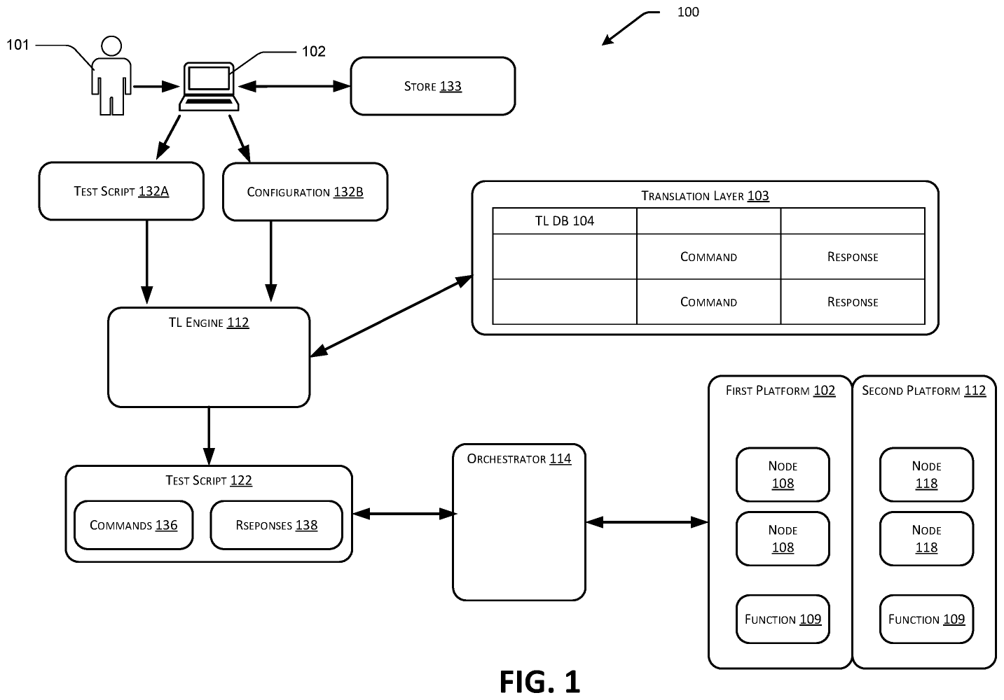

With reference to FIG. 1, a multi-platform test framework 100 is configured to generate a target test script 122 indicative of commands 136 and responses 138 for verifying virtual functions 109 implemented in a virtualized computing environment executing a plurality of virtual machines or containers. The multi-platform test framework 100 is configured to access a source test script 132A encoding commands and responses for verifying a virtual function 109 in a first node 108 configured to operate on a first platform 102. The multi-platform test framework 100 is configured to execute a translation layer 103 configured to translate the commands and responses of the source test script 132A to equivalent commands 136 and responses 138 usable to verify the virtual function 109 in a second node 118 configured to operate on a second platform 112. In an embodiment, the translation comprises syntactic and semantic translation. The multi-platform test framework 100 is configured to validate the equivalent commands and responses. The multi-platform test framework 100 is configured to output the validated commands and responses as a target test script 122 encoding commands and responses usable for verifying the virtual function 109 in the second node 118 configured to operate on the second platform 112. Syntactic translation can refer to translating the source command or response to the equivalent command or response in the target platform while maintaining as close as possible the meaning and structure of the source command or response. Syntactic translation may involve mapping the source command or response to the equivalent command or response in the target platform without changing the underlying logic or functionality of the command or response. However, achieving an accurate translation can also involve considering semantic aspects to ensure that the intended behavior of the command or response is preserved.

Semantic translation process of translating the command or response while preserving the intent of the original context and configuration. Semantic translation can include the underlying context of the specific command or response as well as the broader context of the system as a whole. Achieving semantic fidelity in translating the command or response involves fully translating the underlying context and generating the proper command or response which may involve modifying the syntactic translation. Semantic translation can use mappings, algorithms, and/or machine learning models trained on the source and target platforms to generate translations that are not only syntactically equivalent but also convey the intended purpose of the source command or response.

The commands 136 or responses 138 can include one or more statements in a standardized format that is readable by test units, management tools, etc. For example, the commands 136 or responses 138 can be written in a markup language. A command 136 or response 138 can have one or more expressions which have concrete values and/or a reference to another command 136 or response 138. The command 136 or response 138 can have a mapping. A store 133 of commands 136 or responses 138 is optionally available. In some cases the commands 136 or responses 138 in the store 133 have associated version numbers.

An operator 101 enters a command 136 or response 138 in computer 102 which outputs a test script 132A which defines a test command that is desired to be tested in the first platform 102 or second platform 112. The operator 101 enters the command 136 or response 138 manually and optionally by including references to one or more other commands 136 or responses 138 from store 102. The operator 101 is provided the option to include references within command 136 or response 138 to other commands 136 or responses 138 in order to create more complex commands 136 or responses 138. The translation layer 103 processes the test script 132A into output test script 122 which is suitable for input to the target platform (first platform 102, second platform 112).

In one embodiment, translation layer 103 includes functionality that uses a data-driven model that uses translation layer database 104 to generate the commands and responses based on the input test script statements, configuration data, and other information. In an embodiment, the test script and configuration data, and other information can be specific to a particular target platform where the test script is to be deployed. In an embodiment, the data-driven model matches equivalent commands and responses to those in the input test script. The translation layer can include a classifier and can database 104 which can include one or more tables or other data structures. In an embodiment, the classifier searches a set of table entries until a match is found for a particular combination of commands, responses, configuration data, and other information. If no match is found, the particular combination can be allocated to a default action, such as return an indication that the input is not valid. The translation layer can also perform a consistency check to verify that the particular combination of commands, responses, configuration data, and other information include valid entries or that there are otherwise no conflicting inputs.

Once the output test script 122 is received at the orchestrator 112 the orchestrator executes the output test script 122 in order to test the function 109 in the first platform 102 or second platform 112. In some embodiments, the operator can enter a revision to the input test script 132A. The output test script 122 can be updated to effect the revision.

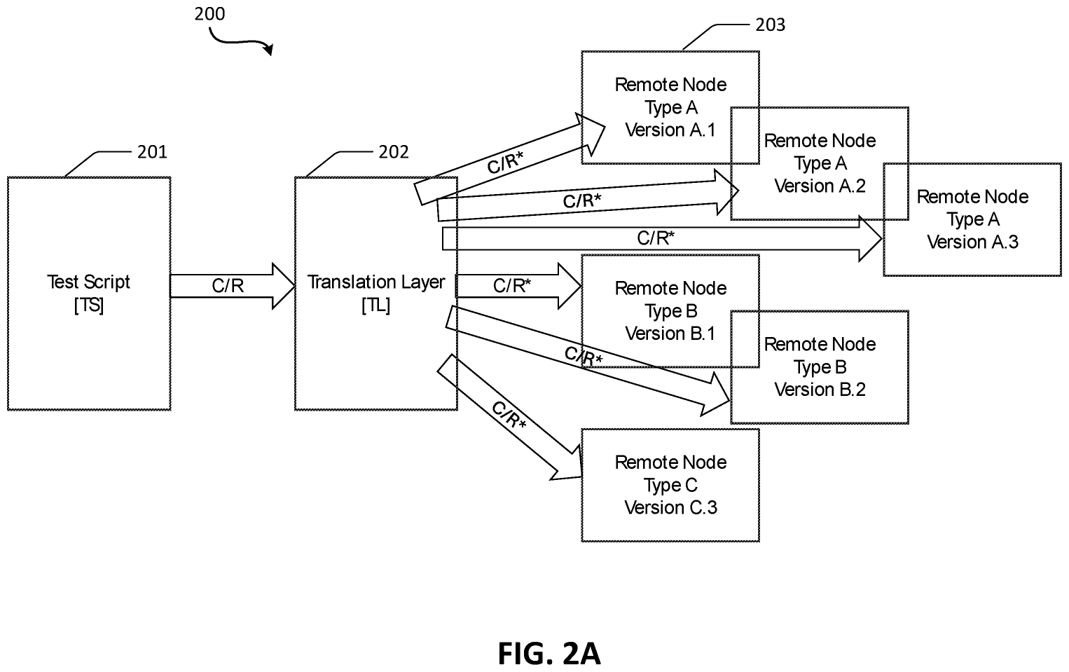

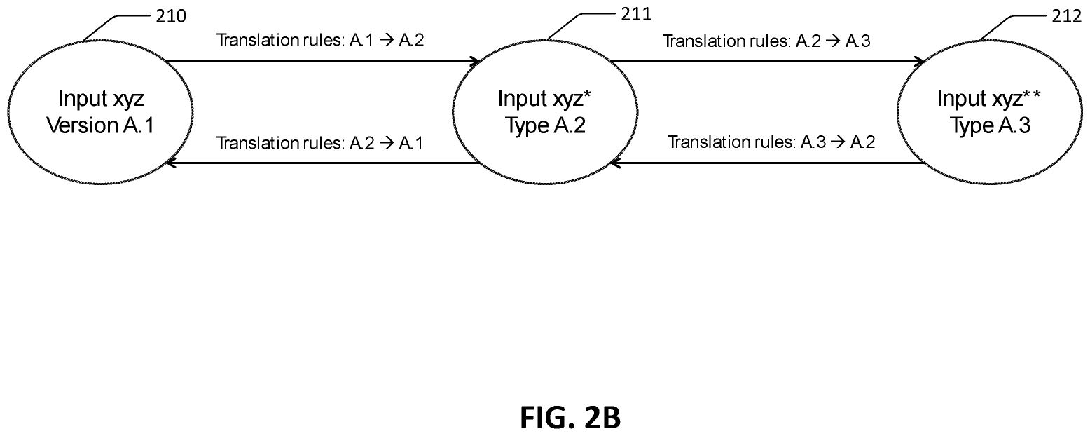

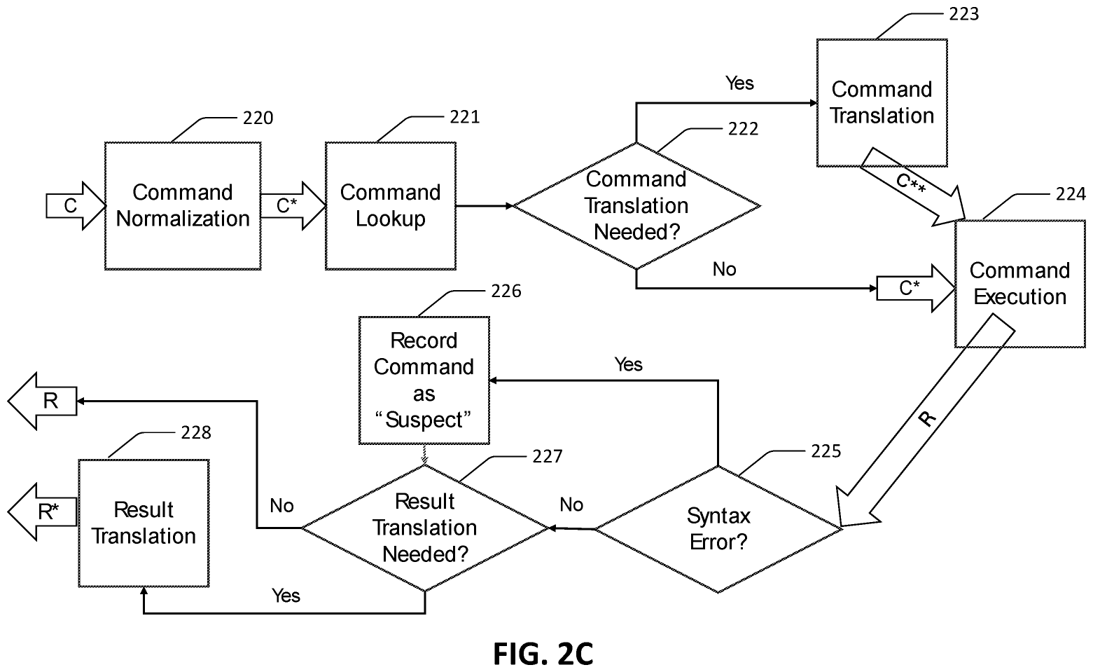

FIG. 2A illustrates an example of a multi-platform test framework 200 and various remote nodes 203, where the remote node is either a test tool, device under test or platform, and where C/R=Command/Response.

In an initialization phase, the translation layer 202 identifies the type of a remote node 203 (e.g., Type B) and 2) its version (e.g., Version B.2). This information can be either provided by the user, discovered by the translation layer 202, or both (e.g., the user provides the type of the remote node and TL retrieves version information). The information is stored in a translation layer database which includes definitions of commands/command response translations received in a test script 201. These translations include rules for converting input strings into output strings, where:
strings are command patterns (such as regular expression match commands) and
translations include string manipulation rules (such as regular expression substitution commands).

In the example shown in FIG. 2B, input string matching pattern xyz 210 (that is supported by node of Type A and version A.1) is translated into a string matching pattern xyz* 211 (that is supported by node of Type A and version A.2). For every transition (e.g., A.1 to A.2), there is a corresponding transition in the opposite direction (from A.2 to A.1) which defines rules for converting input string matching pattern xyz* into a string matching pattern 212 xyz**.

One example of a command translation includes the following scenario: the same action is performed by the remote node as a response to the command exit (on version A.1), quit (A.2), and close (A.3). When command exit is received by the translation layer and the remote node's version is A.2, the key-word exit would be replaced by quit. In case the remote node's version was A.3, the quit key-word would next be replaced by close and this command would be sent to the node for processing. It is also possible to define translation transitions which skip intermediate translon nodes, e.g., from A.1 to A.3. This enables faster processing (one rule) with a potential increase in database complexity.

In an embodiment, the translation layer may further implement a translation graph, where nodes are string match regular expression patterns. The goal is to determine whether a given string may require conversion. Transitions (edges) may take several forms, such as:
String substitution regular expressions
Other string manipulation rules, such as string reordering, key-word injection
Expressions (e.g., code that is executed, for example on the remote node to collect additional information)

The purpose of the transitions is to define rules/actions for converting an input string into an output string.

FIG. 2C illustrates an example of a translation layer workflow. The translation layer intercepts all commands that are sent to remote nodes for execution. The translation layer workflow includes the following operations:

Command Normalization 220; example implementation
Unless protected (i.e., wrapped in quotes) the input string has multiple consecutive space characters replaced by a single space character. One such character is prepended and another appended to the string (to simplify match expressions so that regex anchors do not need to be used)
On remote nodes which support command expansion/auto completion (this is determined by inspecting the node's type information) the command keywords are expanded to a full form, e.g., “sh sub summ”→“show subscriber summary”; such expansion is typically achieved by sending the short form of a command and sending a tab character.

Command lookup 221 is performed in the translation layer translation database. If present on the list of commands that may require translation 222 (i.e., there are known other versions), proper translation rules 223 are applied.

The command is sent for execution 224. In an embodiment, this is done by a module that receives the translated command, not the translation layer itself.

The module executing the command may report a syntax error type 225 of a failure to the translation layer so that the command (with the node's type/version) can be recorded on the list of “suspect” commands 226 which need to be reviewed and which may need to have translation rules defined.

Upon successful command execution, a similar workflow is executed to process the command output. This step is optional 227 and is executed only when the initial/original version of the command is known. For example, if a command version A.1 was received and version A.2 was sent for execution, then the command output will be converted 228 to match the output as generated by command A.1 (the assumption being that scripts implemented for version A.1 not only send commands in that form but also expect and parse outputs as produced by A.1).

Using the universal multi-platform test framework means that there is no need to specifically translate how to verify a function for each node type. Additionally, the validity of a specific test script can be confirmed when it is entered by the operator, and confidence can be carried into verification on other node types. In this way the test script can be implemented in different platforms and environments and reused where the platform is different from the platform for which the test script was originally written.

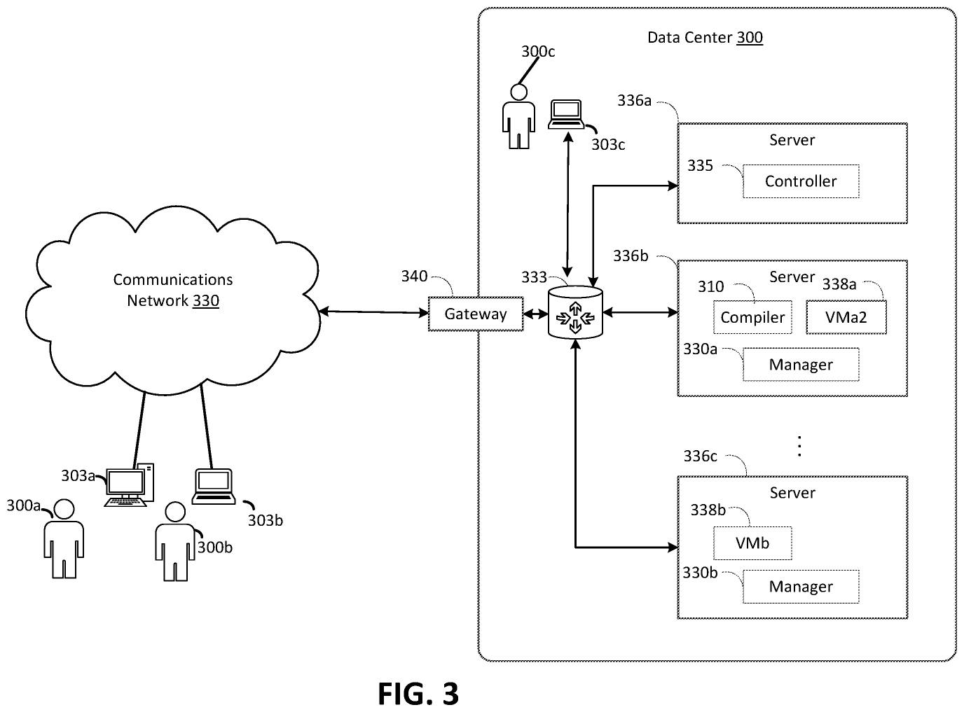

FIG. 3 illustrates an example computing environment in which the embodiments described herein may be implemented. FIG. 3 illustrates a data center 300 that is configured to provide computing resources to users at the customer environment. The customer environment may have user computers that may access services provided by data center 300 via a network 330. The computing resources provided by the data center 300 may include various types of resources, such as computing resources, data storage resources, data communication resources, and the like. Each type of computing resource may be general-purpose or may be available in a number of specific configurations. For example, computing resources may be available as virtual machines. The virtual machines may be configured to execute applications, including Web servers, application servers, media servers, database servers, and the like. Data storage resources may include file storage devices, block storage devices, and the like.

Each type or configuration of computing resource may be available in different configurations, such as the number of processors, and size of memory and/or storage capacity. The resources may in some embodiments be offered to clients in units referred to as instances, such as virtual machine instances or storage instances. A virtual computing instance may be referred to as a virtual machine and may, for example, comprise one or more servers with a specified computational capacity (which may be specified by indicating the type and number of CPUs, the main memory size and so on) and a specified software stack (e.g., a particular version of an operating system, which may in turn run on top of a hypervisor). Networking resources may include virtual networking, software load balancer, and the like. The virtual machines may be configured to execute applications, including Web servers, application servers, media servers, database servers, and the like. Data storage resources may include file storage devices, block storage devices, and the like.

Data center 300 may have various computing resources including servers, routers, and other devices that may provide remotely accessible computing and network resources using, for example, virtual machines. Other resources that may be provided include data storage resources. Data center 300 may also execute functions that manage and control allocation of network resources, such as a network manager 330a.

Network 330 may, for example, be a publicly accessible network of linked networks and may be operated by various entities, such as the Internet. In other embodiments, network 330 may be a private network, such as a dedicated network that is wholly or partially inaccessible to the public. Network 330 may provide access to computers and other devices at the customer environment.

The disclosed embodiments may be implemented in a mobile edge computing (MEC) environment implemented in conjunction with a 4G, 5G, or other cellular network. The MEC environment may include at least some of the components and functionality described in FIG. 1 above. Additionally, components of a 5G network may include network functions such as a Session Management Function (SMF), Policy Control Function (PCF), and N7 interface. A radio access network (RAN) may comprise 5G-capable UEs, a base station gNodeB that communicates with an Access and Mobility Management Function (AMF) in a 5G Core (5GC) network. The 5G network may further comprise a User Plane Function (UPF) and Policy Charging Function (PCF).

It should be appreciated that although the embodiments disclosed above are discussed in the context of virtual machines, other types of implementations can be utilized with the concepts and technologies disclosed herein. It should be also appreciated that the network topology illustrated in FIG. 3 has been greatly simplified and that many more networks and networking devices may be utilized to interconnect the various computing systems disclosed herein. These network topologies and devices should be apparent to those skilled in the art.

FIG. 3 illustrates that computing resources are provided to users 300a, 300b, or 300c (which may be referred herein singularly as “a user 300” or in the plural as “the users 300”) via user computers 303a, 303b, and 303c (which may be referred herein singularly as “a computer 303” or in the plural as “the computers 303”) via communications network 330.

Data center 300 may include servers 336a, 334, and 336c (which may be referred to herein singularly as “a server 336” or in the plural as “the servers 336”) that may be standalone or installed in server racks, and provide computing resources available as virtual machines 338a and 338b (which may be referred to herein singularly as “a virtual machine 338” or in the plural as “the virtual machines 338”). The virtual machines 338 may be configured to execute applications such as Web servers, application servers, media servers, database servers, and the like. Other resources that may be provided include data storage resources (not shown on FIG. 3) and may include file storage devices, block storage devices, and the like. Servers 336 may also execute functions that manage and control allocation of resources in the data center, such as a controller 335. Controller 335 may be a fabric controller or another type of program configured to manage the allocation of virtual machines on servers 336.

In an embodiment, a compiler 310 as described herein may be implemented in server 334. The compiler 310 may include a mapping layer as further described herein (not shown in FIG. 3).

Referring to FIG. 3, communications network 330 may, for example, be a publicly accessible network of linked networks and may be operated by various entities, such as the Internet. In other embodiments, communications network 330 may be a private network, such as a corporate network that is wholly or partially inaccessible to the public.

Communications network 330 may provide access to computers 303. Computers 303 may be computers utilized by users 300. Computer 303a, 303b or 303c may be a server, a desktop or laptop personal computer, a tablet computer, a smartphone, a set-top box, or any other computing device capable of accessing data center 300. User computer 303a or 303b may connect directly to the Internet (e.g., via a cable modem). User computer 303c may be internal to the data center 300 and may connect directly to the resources in the data center 300 via internal networks. Although only three user computers 303a, 303b, and 303c are depicted, it should be appreciated that there may be multiple user computers.

Computers 303 may also be utilized to configure aspects of the computing resources provided by data center 300. For example, data center 300 may provide a Web interface through which aspects of its operation may be configured through the use of a Web browser application program executing on user computer 303. Alternatively, a stand-alone application program executing on user computer 303 may be used to access an application programming interface (API) exposed by data center 300 for performing the configuration operations.

Servers 336 may be configured to provide the computing resources described above. One or more of the servers 336 may be configured to execute a manager 330a or 330b (which may be referred herein singularly as “a manager 330” or in the plural as “the managers 330”) configured to execute the virtual machines. The managers 330 may be a virtual machine monitor (VMM), fabric controller, or another type of program configured to enable the execution of virtual machines 338 on servers 336, for example.

It should be appreciated that although the embodiments disclosed above are discussed in the context of virtual machines, other types of implementations can be utilized with the concepts and technologies disclosed herein.

In the example data center 300 shown in FIG. 3, a network device 333 may be utilized to interconnect the servers 336a and 334. Network device 333 may comprise one or more switches, routers, or other network devices. Network device 333 may also be connected to gateway 340, which is connected to communications network 330. Network device 333 may facilitate communications within networks in data center 300, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 3 has been greatly simplified and that many more networks and networking devices may be utilized to interconnect the various computing systems disclosed herein. These network topologies and devices should be apparent to those skilled in the art.

It should also be appreciated that data center 300 described in FIG. 3 is merely illustrative and that other implementations might be utilized. Additionally, it should be appreciated that the functionality disclosed herein might be implemented in software, hardware or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, smartphone, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

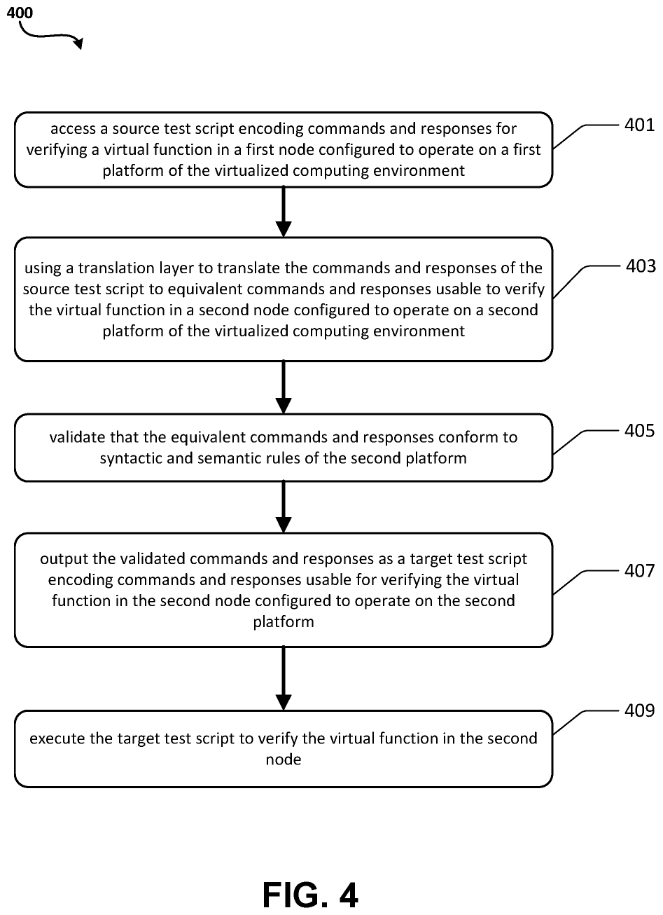

Turning now to FIG. 4, illustrated is an example operational procedure for running a multi-platform test framework configured to generate a target test script indicative of commands and responses for verifying virtual functions implemented in a virtualized computing environment executing a plurality of virtual machines or containers. Such an operational procedure can be provided by one or more components illustrated in FIGS. 1 through 3. The operational procedure may be implemented in a system comprising one or more computing devices. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

It should be appreciated that the logical operations described herein are implemented (1) as a sequence of computer implemented acts or program modules running on a computing system such as those described herein) and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof. Thus, although the routine 400 is described as running on a system, it can be appreciated that the routine 400 and other operations described herein can be executed on an individual computing device or several devices.

Referring to FIG. 4, operation 401 illustrates accessing a source test script encoding commands and responses for verifying a virtual function in a first node configured to operate on a first platform of the virtualized computing environment.

Operation 403 illustrates using a translation layer to translate the commands and responses of the source test script to equivalent commands and responses usable to verify the virtual function in a second node configured to operate on a second platform of the virtualized computing environment. In an embodiment, the translation comprises syntactic and semantic translation of the encoded commands and responses of the source test script. In an embodiment, the syntactic and semantic translation enables equivalency of the commands and responses between the first platform and the second platform and configurations of the first platform and second platform.

Operation 405 illustrates validating that the equivalent commands and responses conform to syntactic and semantic rules of the second platform.

Operation 407 illustrates outputting the validated commands and responses as a target test script encoding commands and responses usable for verifying the virtual function in the second node configured to operate on the second platform.

Operation 409 illustrates executing the target test script to verify the virtual function in the second node.

The various aspects of the disclosure are described herein with regard to certain examples and embodiments, which are intended to illustrate but not to limit the disclosure. It should be appreciated that the subject matter presented herein may be implemented as a computer process, a computer-controlled apparatus, a computing system, an article of manufacture, such as a computer-readable storage medium, or a component including hardware logic for implementing functions, such as a field-programmable gate array (FPGA) device, a massively parallel processor array (MPPA) device, a graphics processing unit (GPU), an application-specific integrated circuit (ASIC), a multiprocessor System-on-Chip (MPSoC), etc.

A component may also encompass other ways of leveraging a device to perform a function, such as, for example, a) a case in which at least some tasks are implemented in hard ASIC logic or the like; b) a case in which at least some tasks are implemented in soft (configurable) FPGA logic or the like; c) a case in which at least some tasks run as software on FPGA software processor overlays or the like; d) a case in which at least some tasks run as software on hard ASIC processors or the like, etc., or any combination thereof. A component may represent a homogeneous collection of hardware acceleration devices, such as, for example, FPGA devices. On the other hand, a component may represent a heterogeneous collection of different types of hardware acceleration devices including different types of FPGA devices having different respective processing capabilities and architectures, a mixture of FPGA devices and other types hardware acceleration devices, etc.

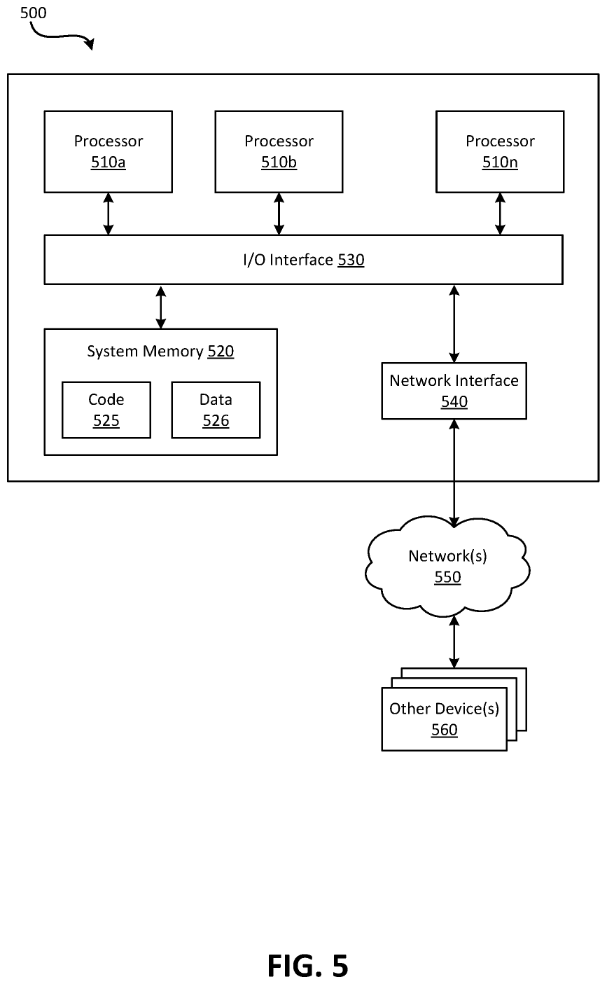

FIG. 5 illustrates a general-purpose computing device 500. In the illustrated embodiment, computing device 500 includes one or more processors 510a, 510b, and/or 510n (which may be referred herein singularly as “a processor 510” or in the plural as “the processors 510”) coupled to a system memory 520 via an input/output (I/O) interface 530. Computing device 500 further includes a network interface 540 coupled to I/O interface 530.

In various embodiments, computing device 500 may be a uniprocessor system including one processor 510 or a multiprocessor system including several processors 510 (e.g., two, four, eight, or another suitable number). Processors 510 may be any suitable processors capable of executing instructions. For example, in various embodiments, processors 510 may be general-purpose or embedded processors implementing any of a variety of instruction set architectures (ISAs), such as the x55, PowerPC, SPARC, or MIPS ISAs, or any other suitable ISA. In multiprocessor systems, each of processors 510 may commonly, but not necessarily, implement the same ISA.

System memory 520 may be configured to store instructions and data accessible by processor(s) 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques and data described above, are shown stored within system memory 520 as code 525 and data 526.

In one embodiment, I/O interface 530 may be configured to coordinate I/O traffic between the processor 510, system memory 520, and any peripheral devices in the device, including network interface 540 or other peripheral interfaces. In some embodiments, I/O interface 530 may perform any necessary protocol, timing, or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components. Also, in some embodiments some or all of the functionality of I/O interface 530, such as an interface to system memory 520, may be incorporated directly into processor 510.

Network interface 540 may be configured to allow data to be exchanged between computing device 500 and other device or devices 560 attached to a network or network(s) 550, such as other computer systems or devices as illustrated in FIGS. 1 through 5, for example. In various embodiments, network interface 540 may support communication via any suitable wired or wireless general data networks, such as types of Ethernet networks, for example. Additionally, network interface 540 may support communication via telecommunications/telephony networks such as analog voice networks or digital fiber communications networks, via storage area networks such as Fibre Channel SANs or via any other suitable type of network and/or protocol.

In some embodiments, system memory 520 may be one embodiment of a computer-accessible medium configured to store program instructions and data as described above for FIGS. 1-4 for implementing embodiments of the corresponding methods and apparatus. However, in other embodiments, program instructions and/or data may be received, sent or stored upon different types of computer-accessible media. A computer-accessible medium may include non-transitory storage media or memory media, such as magnetic or optical media, e.g., disk or DVD/CD coupled to computing device 500 via I/O interface 530. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 500 as system memory 520 or another type of memory. Further, a computer-accessible medium may include transmission media or signals such as electrical, electromagnetic or digital signals, conveyed via a communication medium such as a network and/or a wireless link, such as may be implemented via network interface 540. Portions or all of multiple computing devices, such as those illustrated in FIG. 5, may be used to implement the described functionality in various embodiments; for example, software components running on a variety of different devices and servers may collaborate to provide the functionality. In some embodiments, portions of the described functionality may be implemented using storage devices, network devices, or special-purpose computer systems, in addition to or instead of being implemented using general-purpose computer systems. The term “computing device,” as used herein, refers to at least all these types of devices and is not limited to these types of devices.

Various storage devices and their associated computer-readable media provide non-volatile storage for the computing devices described herein. Computer-readable media as discussed herein may refer to a mass storage device, such as a solid-state drive, a hard disk or CD-ROM drive. However, it should be appreciated by those skilled in the art that computer-readable media can be any available computer storage media that can be accessed by a computing device.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing devices discussed herein. For purposes of the claims, the phrase “computer storage medium,” “computer-readable storage medium” and variations thereof, does not include waves, signals, and/or other transitory and/or intangible communication media, per se.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the disclosed computing devices in order to store and execute the software components and/or functionality presented herein. It is also contemplated that the disclosed computing devices may not include all of the illustrated components shown in FIG. 5, may include other components that are not explicitly shown in FIG. 5, or may utilize an architecture completely different than that shown in FIG. 5.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements, and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be appreciated any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual computing devices and/or operational states of the computing cluster may be distinguished by numerical designations without such designations corresponding to the claims or even other paragraphs of the Summary and/or Detailed Description. For example, any designation of a “first operational state” and “second operational state” of the computing cluster within a paragraph of this disclosure is used solely to distinguish two different operational states of the computing cluster within that specific paragraph—not any other paragraph and particularly not the claims.

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

The disclosure presented herein also encompasses the subject matter set forth in the following clauses:

Clause 1: A multi-platform test framework implemented in a system comprising:
one or more processors; and
a memory in communication with the one or more processors, the memory having computer-readable instructions stored thereupon that, when executed by the one or more processors, cause the system to execute the multi-platform test framework, the multi-platform test framework configured to generate a target test script indicative of commands and responses for verifying virtual functions implemented in a virtualized computing environment executing a plurality of virtual machines or containers, the multi-platform test framework further configured to:
access a source test script encoding commands and responses for verifying a virtual function in a first node configured to operate on a first platform of the virtualized computing environment;
using a translation layer to translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform;
output the validated commands and responses as a target test script encoding commands and responses usable for verifying the virtual function in the second node configured to operate on the second platform; and
execute the target test script to verify the virtual function in the second node.

Clause 2: The multi-platform test framework of clause 1, wherein translation layer abstracts the encoded commands and responses of the source test script from underlying details of the first node or second node.

Clause 3: The multi-platform test framework of any of clauses 1-2, wherein the translation layer includes a mapping component configured to map commands and responses between nodes.

Clause 4: The multi-platform test framework of any of clauses 1-3, further comprising performing a consistency check of the commands and responses.

Clause 5: The multi-platform test framework of any of clauses 1-4, wherein the translating the commands and responses comprises resolving dependencies between the commands and responses and resources available to the second node.

Clause 6: The multi-platform test framework of any of clauses 1-5, further comprising in response to receiving a revision to the source test script, updating the equivalent commands and responses to implement the revision.

Clause 7: The multi-platform test framework of clauses 1-6, wherein the test script includes a declarative statement indicating a goal state and a set of fields indicating configuration data.

Clause 8: The multi-platform test framework of any of clauses 1-7, wherein the first platform is a 5G platform and the second platform is a Any-G platform.

Clause 9: The multi-platform test framework of any of clauses 1-8, wherein the first platform is a first service provider platform and the second platform is a second service provider platform.

Clause 10: The multi-platform test framework of any of clauses 1-9, wherein the first node is a test tool or device under test.

Clause 11: The multi-platform test framework of any of clauses 1-10, wherein the first node or second node comprises a type and version.

Clause 12: The multi-platform test framework of any of clauses 1-11, wherein the translation layer comprises rules for converting input strings into output strings, wherein:
strings are command patterns; and
string manipulation rules.

Clause 13: The multi-platform test framework of any of clauses 1-12, wherein the translation layer comprises a translation graph wherein:
nodes of the translation graph comprise string match expression patterns; and
edges of the translation graph comprise one or more of
string substitution regular expressions;
string manipulation rules; or
expressions.

Clause 14: A computer-readable storage medium having computer-executable instructions stored thereupon which, when executed by one or more processors of a system, cause the system to perform operations comprising:
access a source test script encoding commands and responses for verifying a virtual function in a first node configured to operate on a first platform of the virtualized computing environment;
translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform; and
output the validated commands and responses as a target test script encoding commands and responses usable for verifying the virtual function in the second node configured to operate on the second platform.

Clause 15: The computer-readable storage medium of clause 14, wherein the first platform is a 5G platform and the second platform is a Any-G platform.

Clause 16: The computer-readable storage medium of any of clauses 14 and 15, wherein the first platform is a first service provider platform and the second platform is a second service provider platform.

Clause 17: The computer-readable storage medium of any clauses 14-16, wherein the first node is a test tool or device under test.

Clause 18: The computer-readable storage medium of any clauses 14-17, wherein the first node or second node comprises a type and version.

Clause 19: The computer-readable storage medium of any clauses 14-18, wherein the translation is performed by a translation layer that comprises rules for converting input strings into output strings, wherein:
strings are command patterns; and
the translation include string manipulation rules.

Clause 20: A computer-readable storage medium having computer-executable instructions stored thereupon which, when executed by one or more processors of a system, cause the system to perform operations comprising:
receiving a configuration file that identifies a high-level representation indicative of an intended updated state of a virtualized computing network implemented across a plurality of sites each comprising a plurality of computing nodes, the configuration file further including a policy indicative of constraints for changes that are permitted in the virtualized computing network and a current state of the virtualized computing network;
based on the high-level representation, policy, and the current state of the virtualized computing network, generating a set of operations that are deployable in a specified portion of the virtualized computing network, wherein the set of operations configure the virtualized computing network to achieve the intended updated state of the virtualized computing network when deployed; and
deploying the set of operations in the virtualized computing network.

Clause 18: The computer-readable storage medium of clause 17, wherein the set of operations are abstracted from underlying details of user-specific configurations of the virtualized computing network.

Clause 19: The computer-readable storage medium of any of clauses 17 and 18, wherein the generating the set of operations is performed by a network manager configured to translate the high-level representation to the set of operations.

Clause 20: A method comprising:
access a source test script encoding commands and responses for verifying a virtual function in a first node configured to operate on a first platform of the virtualized computing environment;
using a translation layer to translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform;
output the validated commands and responses as a target test script encoding commands and responses usable for verifying the virtual function in the second node configured to operate on the second platform; and
executing the target test script to verify the virtual function in the second node.

1. A multi-platform test framework implemented in a system comprising:
one or more processors; and
a memory in communication with the one or more processors, the memory having computer-readable instructions stored thereupon that, when executed by the one or more processors, cause the system to execute the multi-platform test framework, the multi-platform test framework configured to generate a target test script indicative of commands and responses for verifying virtual functions implemented in a virtualized computing environment executing a plurality of virtual machines or containers, the multi-platform test framework further configured to:
access a source test script encoding commands and responses for verifying a virtual function in a first node configured to operate on a first platform of the virtualized computing environment;
using a translation layer to translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform;
output the validated commands and responses as a target test script encoding commands and responses usable for verifying the virtual function in the second node configured to operate on the second platform; and
execute the target test script to verify the virtual function in the second node.

2. The system of claim 1, wherein translation layer abstracts the encoded commands and responses of the source test script from underlying details of the first node or second node.

3. The system of claim 1, wherein the translation layer includes a mapping component configured to map commands and responses between nodes.

4. The system of claim 1, further comprising performing a consistency check of the commands and responses.

5. The system of claim 1, wherein the translating the commands and responses comprises resolving dependencies between the commands and responses and resources available to the second node.

6. The system of claim 1, further comprising in response to receiving a revision to the source test script, updating the equivalent commands and responses to implement the revision.

7. The system of claim 1, wherein the test script includes a declarative statement indicating a goal state and a set of fields indicating configuration data.

8. The system of claim 1, wherein the first platform is a 5G platform and the second platform is a Any-G platform.

9. The system of claim 1, wherein the first platform is a first service provider platform and the second platform is a second service provider platform.

10. The system of claim 1, wherein the first node is a test tool or device under test.

11. The system of claim 1, wherein the first node or second node comprises a type and version.

12. The system of claim 1, wherein the translation layer comprises rules for converting input strings into output strings, wherein:
strings are command patterns; and
string manipulation rules.

13. The system of claim 1, wherein the translation layer comprises a translation graph wherein:
nodes of the translation graph comprise string match expression patterns; and
edges of the translation graph comprise one or more of:
string substitution regular expressions;
string manipulation rules; or
expressions.

14. A computer-readable storage medium having computer-executable instructions stored thereupon which, when executed by one or more processors of a system, cause the system to perform operations comprising:
access a source test script encoding commands and responses for verifying a virtual function in a first node configured to operate on a first platform of the virtualized computing environment;
translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform; and
output the validated commands and responses as a target test script encoding commands and responses usable for verifying the virtual function in the second node configured to operate on the second platform.

15. The computer-readable storage medium of claim 14, wherein the first platform is a 5G platform and the second platform is a Any-G platform.

16. The computer-readable storage medium of claim 14, wherein the first platform is a first service provider platform and the second platform is a second service provider platform.

17. The computer-readable storage medium of claim 14, wherein the first node is a test tool or device under test.

18. The computer-readable storage medium of claim 14, wherein the first node or second node comprises a type and version.

19. The computer-readable storage medium of claim 14, wherein the translation is performed by a translation layer that comprises rules for converting input strings into output strings, wherein:
strings are command patterns; and
the translation include string manipulation rules.

20. A method comprising:
access a source test script encoding commands and responses for verifying a virtual function in a first node configured to operate on a first platform of the virtualized computing environment;
using a translation layer to translate the commands and responses of the source test script to equivalent commands and responses usable to verify the virtual function in a second node configured to operate on a second platform of the virtualized computing environment, wherein the translation comprises syntactic and semantic translation of the encoded commands and responses of the source test script, and wherein the syntactic and semantic translation enables equivalency of the commands and responses between the first platform and the second platform and configurations of the first platform and second platform;
validate that the equivalent commands and responses conform to syntactic and semantic rules of the second platform;
output the validated commands and responses as a target test script encoding commands and responses usable for verifying the virtual function in the second node configured to operate on the second platform; and
executing the target test script to verify the virtual function in the second node.
